(19) United States
(12) Patent Application Publication
(10) Pub. No.: US 2021/0291498 A1
(43) Pub. Date: Sep. 23, 2021

(54) LIQUID REPELLENT LAMINATE AND PROTECTIVE SHEET FOR DISPLAY

(71) Applicant: TOSHIBA TEC KABUSHIKI KAISHA, Tokyo (JP)

(72) Inventor: Masashi SEKI, Sunto Shizuoka (JP)

(73) Assignee: TOSHIBA TEC KABUSHIKI KAISHA, Tokyo (JP)

(21) Appl. No.: 17/096,541

(22) Filed: Nov. 12, 2020

(30) Foreign Application Priority Data
Mar. 23, 2020 (JP) 2020-051677

(51) Int. Cl. B32B 27/08; G06F 1/16; H04B 1/3888; B05D 1/00; B32B 27/36; B32B 27/16; B32B 27/20; B32B 27/32; B32B 27/30; B32B 7/12; C09J 7/29; C09J 7/24; C08F 283/02; C08G 61/04; C09D 165/00

(52) U.S. Cl. CPC B32B 27/08; H04B 2001/3894; H04B 1/3888; B05D 1/60; B32B 27/36; B32B 27/16; B32B 27/20; B32B 27/32; B32B 27/302; B32B 7/12; C09J 7/29; C09J 7/24; C08F 283/02; C08G 61/04; C09D 165/00; G06F 1/1637

(57) ABSTRACT

A liquid repellent laminate according to an embodiment includes a transparent substrate having a first principal face and a second principal face as a rear face of the first principal face, and a liquid repellent membrane supported on the first principal face of the transparent substrate. The liquid repellent membrane is a monomolecular membrane of a fluorine-containing organic compound that binds to a surface of the transparent substrate through a binding moiety represented by —Z—O—* (wherein Z represents an atomic group containing a Si atom, and * represents a binding site to the surface of the transparent substrate) and includes a perfluoroalkyl group having 4 or less carbon atoms at a terminal, and the fluorine-containing organic compound undergoes intermolecular bonding between the fluorine-containing organic compounds adjacent to each other by mutual binding of Z in the formula.

### CROSS-REFERENCE TO RELATED APPLICATION

This application is based upon and claims the benefit of priority from Japanese Patent Application No. 2020-051677, filed on Mar. 23, 2020 the entire contents of which are incorporated herein by reference.

### FIELD

Embodiments described herein relate generally to a liquid repellent laminate and a protective sheet for a display.

### BACKGROUND

Recently, while a smartphone or a tablet personal computer is spreading rapidly, a protective sheet for a display for protecting a display area of a display of such a device is variously proposed.

In such a protective sheet, a demand for an antifouling function is increasing. Dirt such as sebum, sweat, or filthy water adhered to the protective sheet not only deteriorates cleanliness, but also lowers the visibility of an image.

In order to impart an antifouling function to a protective sheet, a method for increasing a contact angle of the surface of the sheet using a fluorine-based material, a silicone-based material, or the like is generally used. For example, a method for providing a transparent fluorine-based liquid repellent membrane on the surface is exemplified.

As the fluorine-based liquid repellent membrane, a silane-based compound having a long-chain perfluoroalkyl group is often used. However, when the number of carbon atoms of the perfluoroalkyl group is 5 or more, the compound is not degraded in nature, and therefore, there is a problem of environmental load. Further, a degradation product of a silane-based compound having a long-chain perfluoroalkyl group is highly accumulated in a living organism, and therefore, there is also a concern that the working environment is poor.

On the other hand, when the number of carbon atoms of the long-chain perfluoroalkyl group contained in the silane-based compound was set to 4 or less, there was a problem that the liquid repellency decreases, and also the abrasion resistance decreases.

### DESCRIPTION OF THE DRAWINGS

FIG. 1 is a schematic view showing an example of a cross section of a liquid repellent laminate according to an embodiment.

FIG. 2 is a schematic view showing another example of a cross section of a liquid repellent laminate according to an embodiment.

FIG. 3 is a schematic view showing another example of a cross section of a liquid repellent laminate according to an embodiment.

FIG. 4 is a schematic view showing an example of a liquid repellent membrane.

FIG. 5 is a schematic view showing another example of a liquid repellent membrane.

FIG. 6 is a schematic view showing another example of a liquid repellent membrane.

### DETAILED DESCRIPTION

An object to be achieved by embodiments is to provide a liquid repellent laminate having few problems of environmental load and working environment and having excellent liquid repellency and abrasion resistance, and a protective sheet for a display using the same.

According to an embodiment, a liquid repellent laminate including a transparent substrate having a first principal face and a second principal face as a rear face of the first principal face, and a liquid repellent membrane supported on the first principal face of the transparent substrate, wherein

the liquid repellent membrane is a monomolecular membrane of a fluorine-containing organic compound that binds to a surface of the transparent substrate through a binding moiety represented by —Z—O—* (wherein Z represents an atomic group containing a Si atom, and * represents a binding site to the surface of the transparent substrate) and includes a perfluoroalkyl group having 4 or less carbon atoms at a terminal, and

the fluorine-containing organic compound undergoes intermolecular bonding between the fluorine-containing organic compounds adjacent to each other by mutual binding of Z in the formula is provided.

Further, according to another embodiment, a protective sheet for a display including the liquid repellent laminate according to the above embodiment is provided.

Hereinafter, an embodiment will be described in detail with reference to the drawings.

### First Embodiment

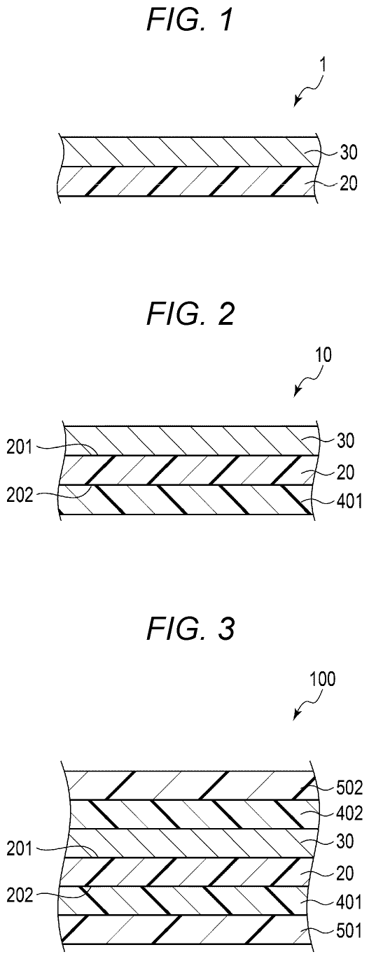

FIG. 1 shows a schematic view of a cross section of a liquid repellent laminate according to an embodiment.

A liquid repellent laminate 1 shown in FIG. 1 is a preferred member for protecting a display area of a display of a mobile communication terminal such as a smartphone or a tablet personal computer or a computer or the like. The liquid repellent laminate 1 includes a transparent substrate 20 and a liquid repellent membrane 30 supported on the transparent substrate 20. Hereinafter, the liquid repellent membrane 30 and the transparent substrate 20 are described in detail.

(Transparent Substrate)

The transparent substrate 20 is not particularly limited as long as the transparent substrate is a molded body that transmits light. Examples of a material of the transparent substrate 20 include polyethylene terephthalate (PET), polybutylene terephthalate, polyethylene naphthalate (PEN), polycarbonate, a methyl polymethacrylate copolymer, triacetyl cellulose, polyolefin, polyamide, polyvinyl chloride, amorphous polyolefin, a cycloolefin polymer, a cycloolefin copolymer, an acrylate resin, and a urethane acrylate resin.

In one aspect, the transparent substrate 20 is preferably formed from a polyester. Illustrative polyesters, such as a film to be stuck to a display area of a display or the like, a film for protecting various types of members, or the like, a biaxially stretched film composed of PET or PEN, have excellent mechanical properties, heat resistance, chemical resistance, and the like, and therefore are preferred.

The transparent substrate 20 may contain organic or inorganic particles. In that case, the windability, transportability, and the like of the transparent substrate are improved. Examples of the particles that can be contained in the transparent substrate 20 include calcium carbonate particles, calcium oxide particles, aluminum oxide particles, kaolin, silicon oxide particles, zinc oxide particles, cross-linked acrylic resin particles, cross-linked polystyrene resin particles, urea resin particles, melamine resin particles, and cross-linked silicone resin particles.

Further, the transparent substrate 20 may further contain a colorant, an antistatic agent, a UV absorber, an antioxidant, a lubricant, a catalyst, another resin, or the like that does not impair transparency.

The form of the transparent substrate 20 is, for example, a film form or a sheet form. The thickness of the transparent substrate 20 is not particularly limited, but the thickness of the substrate directly affects the rigidity of a molded product, and from this viewpoint, the thickness may be, for example, between 50 μm and 100 μm.

(Liquid Repellent Membrane)

The liquid repellent membrane 30 is a membrane having liquid repellency. Here, the “liquid repellency” is a concept including both water repellency and oil repellency. Specifically, the “liquid repellency” refers to a property of repelling a liquid with respect to an aqueous or oily material in a liquid form, a semi-solid form, a gel form, or the like.

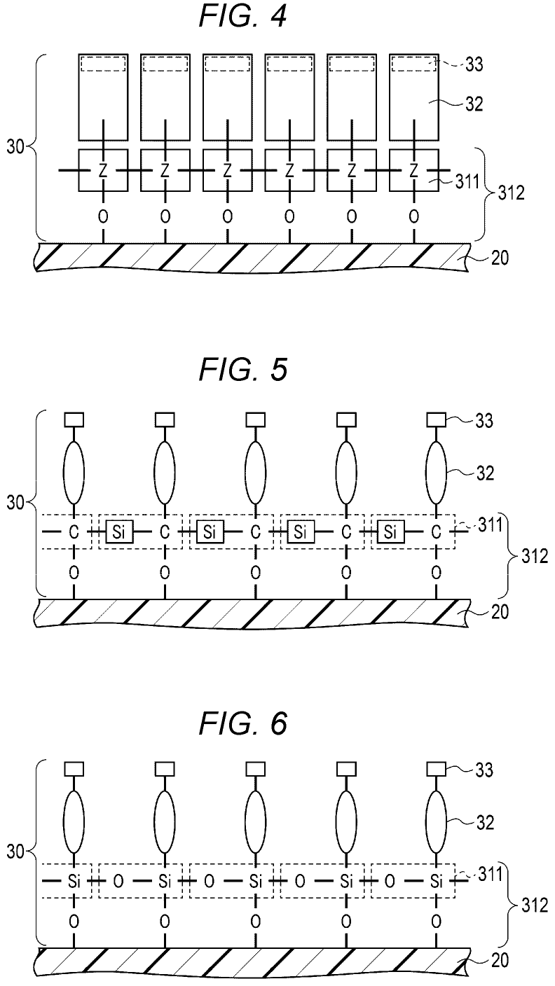

The liquid repellent membrane 30 is a monomolecular membrane of a fluorine-containing organic compound. The structure of the liquid repellent membrane 30 are described below with reference to FIGS. 4 to 6.

FIGS. 4 to 6 are each a schematic view showing an example of the liquid repellent membrane.

As described above, the liquid repellent membrane 30 is a monomolecular membrane of a fluorine-containing organic compound. The fluorine-containing organic compound (hereinafter also referred to as “fluorine compound”) includes a binding moiety 312 to the surface of the transparent substrate 20, a spacer linking group 32, and a perfluoroalkyl group 33. The fluorine compound is a molecule that includes the binding moiety 312 at one terminal and the perfluoroalkyl group (terminal perfluoroalkyl group) 33 at the other terminal, and includes the spacer linking group 32 therebetween, and the terminal perfluoroalkyl group 33 is present in a surface layer of the liquid repellent membrane 30. The fluorine compound may be linear or branched, but is preferably linear in order to increase the binding density to the transparent substrate 20 and improve the liquid repellency and abrasion resistance.

The binding moiety 312 is, for example, a moiety bound to the transparent substrate 20 by a reaction with a functional group present on the surface of the transparent substrate 20. Hereinbelow, the binding moiety 312 is sometimes represented by —Z—O—* . Here, Z represents a moiety denoted by the reference numeral 311 in FIGS. 4 to 6, and * represents a binding site to the surface of the transparent substrate 20. The details are described later.

The fluorine compound as a raw material of the liquid repellent membrane 30 includes, for example, a reactive functional group in a moiety corresponding to the binding moiety 312. In that case, by reacting the reactive functional group with the functional group present on the surface of the transparent substrate 20, the binding moiety 312 binds to the transparent substrate 20. The reactive functional group is, for example, a hydroxy group, an epoxy group, an amino group, or an alkoxy group, or an unsaturated hydrocarbon group such as a methacrylic group or a vinyl group, or a mercapto group. The functional group present on the surface of the transparent substrate 20 is, for example, a hydroxy group, a carboxy group, an amino group, or a thiol group.

Alternatively, the fluorine compound as the raw material of the liquid repellent membrane 30 includes an alkoxysilyl group in a moiety corresponding to the binding moiety 312. In that case, by reacting a silanol group generated by hydrolysis of the alkoxysilyl group with the functional group such as a hydroxy group present on the surface of the transparent substrate 20, the binding moiety 312 can bind to the transparent substrate 20.

Alternatively, the fluorine compound as the raw material of the liquid repellent membrane 30 includes an alkoxysilyl group and another reactive functional group in a moiety corresponding to the binding moiety 312. Here, the another reactive functional group is, for example, a hydroxy group, an epoxy group, an amino group, or an alkoxy group, or an unsaturated hydrocarbon group such as a methacrylic group or a vinyl group, or a mercapto group. In that case, for example, by reacting the another reactive functional group with the functional group present on the surface of the transparent substrate 20, the binding moiety 312 can be bound to the transparent substrate 20. Further, by subjecting a silanol group generated by hydrolysis of the alkoxysilyl group to dehydration condensation, an intermolecular bond can be formed between the fluorine compounds.

Hereinafter, the fluorine compound as the raw material and the fluorine compound forming the monomolecular membrane in the liquid repellent membrane 30 are simply referred to as “fluorine compound” without distinction.

In the fluorine compounds adjacent to each other on the transparent substrate 20, the binding moieties 312 bind to each other. More specifically, when the binding moiety 312 is represented by —Z—O—* (formula (i)), the fluorine compounds adjacent to each other on the transparent substrate 20 have an intermolecular bond formed by mutual binding of Z. Here, Z in the formula (i) is a moiety represented by the reference numeral 311, and is an atomic group containing a Si atom. * represents a binding site to the surface of the transparent substrate 20. By intermolecular bonding between the fluorine-containing organic compounds constituting the monomolecular membrane in this manner, the liquid repellency and abrasion resistance are improved.

Z (311) is an atomic group containing a Si atom as described above.

According to one example, Z (311) may be an atomic group containing a C atom that binds to an O atom, and a Si atom as shown in FIG. 5. In that case, the fluorine compounds adjacent to each other on the transparent substrate 20 bind to each other through an intermolecular bond of a —C—Si—C—Si— chain formed by mutual binding of Z (311).

According to another example, Z (311) may be an atomic group containing a Si atom that binds to an O atom, and an O atom as shown in FIG. 6. In that case, the fluorine compounds adjacent to each other on the transparent substrate 20 bind to each other through an intermolecular bond of a siloxane bond (—O—Si—O—Si— chain) formed by mutual binding of Z (311).

In one aspect, the molecular bond formed between the fluorine compounds constituting the monomolecular membrane is preferably a —C—Si—C—Si— chain.

The terminal perfluoroalkyl group 33 is, for example, a linear perfluoroalkyl group. The number of carbon atoms of the terminal perfluoroalkyl group 33 can be selected within a range of 4 or less (C1 to C4). The terminal perfluoroalkyl group 33 is preferably upright along the perpendicular line direction with respect to the surface of the transparent substrate 20. When the number of carbon atoms of the terminal perfluoroalkyl group 33 is increased, it becomes easy to make the terminal perfluoroalkyl group 33 upright, but such a terminal perfluoroalkyl group has an adverse effect on a human body such as carcinogenicity.

The spacer linking group 32 links the terminal perfluoroalkyl group 33 to the binding moiety 312. The presence of the spacer linking group 32 is advantageous in that the terminal perfluoroalkyl group 33 has an upright structure along the perpendicular line direction with respect to the surface of the transparent substrate 20. In one aspect, the terminal perfluoroalkyl group 33 preferably binds to a residual moiety of the fluorine compound through an ether bond. The spacer linking group 32 is, for example, a perfluoropolyether group.

As a raw material of such a liquid repellent membrane 30, for example, a fluorine compound represented by the following general formula (1) or (2) can be used.

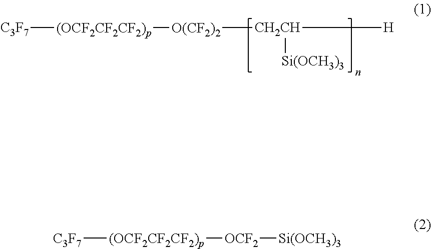

In the general formulae (1) and (2), p is a natural number between 1 and 50 and n is a natural number between 1 and 10.

Alternatively, as the raw material of the liquid repellent membrane 30, for example, a fluorine compound in which a moiety to become the binding moiety 312 includes an alkoxysilyl group and a reactive functional group R as represented by the following general formula (3) can also be used.

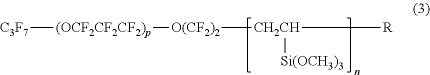

In the general formula (3), p is a natural number between 1 and 50, n is a natural number between 1 and 10, and R is the above-mentioned reactive functional group.

The film thickness of the liquid repellent membrane 30 is not particularly limited. The film thickness may be, for example, between 10 nm and 100 nm. The liquid repellent membrane of the embodiment uses an extremely thin monomolecular membrane, and therefore has an extremely low effect on the transparency of the transparent substrate.

The liquid repellent laminate shown in FIG. 1 is obtained, for example, as follows.

First, when the transparent substrate 20 includes almost no functional groups such as a hydroxy group necessary for binding to the fluorine compound on the surface, the transparent substrate 20 is preferably subjected to a pretreatment as described below prior to the formation of the liquid repellent membrane 30.

For example, a first principal face 201 of the transparent substrate 20 is subjected to an ion plasma treatment in an argon-oxygen mixed gas, thereby modifying the surface. The ion plasma treatment is performed, for example, as follows. That is, the transparent substrate 20 is placed in a vacuum chamber, and air in the chamber is withdrawn under vacuum. Then, the atmosphere surrounding the transparent substrate 20 is replaced with an argon-oxygen mixed gas, and thereafter, a plasma is generated.

By performing the ion plasma treatment in an atmosphere containing oxygen, the surface of the transparent substrate 20 is modified with a hydroxy group, In addition thereto, by performing the ion plasma treatment in an atmosphere containing argon, dirt adhered to the surface of the transparent substrate 20 is removed.

The ion plasma treatment is preferably performed in an argon-oxygen mixed gas having an oxygen concentration of 50 vol % or less, more preferably performed in an argon-oxygen mixed gas having an oxygen concentration within a range of 20 to 50 vol %. When the oxygen concentration is too high, the surface of the transparent substrate 20 may be damaged to cause surface roughness. When surface roughness is caused on the transparent substrate 20, the binding to the liquid repellent membrane 30 may be insufficient.

The ion plasma treatment is preferably performed for 100 seconds or more, more preferably performed for 200 seconds or more. When the plasma irradiation time is too short, the surface modification of the transparent substrate 20 may not be sufficiently performed.

Subsequently, the fluorine compound is supplied to the surface of the transparent substrate 20 by a vacuum deposition method. Then, hydrolysis and dehydration condensation are caused, thereby binding the fluorine compound to the surface of the transparent substrate 20 and also allowing intermolecular bonding of the fluorine compound to occur. In this manner, the liquid repellent laminate 1 having the liquid repellent membrane 30 on the transparent substrate 20 can be formed.

### Second Embodiment

FIG. 2 shows a schematic view of a cross section of a liquid repellent laminate according to a second embodiment.

A liquid repellent laminate 10 shown in FIG. 2 includes a transparent substrate 20, a liquid repellent membrane 30 supported on one principal face (first principal face) 201 of the transparent substrate 20, and a first adhesive layer 401 supported on the other principal face (second principal face) 202 of the transparent substrate 20. The liquid repellent laminate 10 is the same as the liquid repellent laminate 1 shown in FIG. 1 except that the first adhesive layer 401 is further included. When the liquid repellent laminate 1 shown in FIG. 1 is used as a protective sheet for a display of a smartphone, a personal computer, or the like, the laminate is attached by sticking the first adhesive layer 401 included in the liquid repellent laminate 10 shown in FIG. 2 to a display area of a display.

The liquid repellent laminate 10 shown in FIG. 2 generally exists in the form in which the surface layer is protected by coating with a protective film in a distribution process before being stuck to a display or the like. That is, the liquid repellent laminate 10 shown in FIG. 2 is distributed in the form in which a protective film releasably laminated is included as an outermost layer at each of the first principal face 201 side and the second principal face 202 side of the transparent substrate 20. One example thereof is shown in FIG. 3.

### Third Embodiment

FIG. 3 is a schematic view of a cross section of a liquid repellent laminate according to a third embodiment.

A liquid repellent laminate 100 shown in FIG. 3 includes a transparent substrate 20, a liquid repellent membrane 30 supported on a first principal face 201 of the transparent substrate 20, a first adhesive layer 401 supported on a second principal face 202 of the transparent substrate 20, a second protective film 502 and a first protective film 501 as an outermost layer at each of the first principal face 201 side and the second principal face 202 side of the transparent substrate 20, and a second adhesive layer 402 supported on the second protective film 502.

The liquid repellent laminate 100 is the same as the liquid repellent laminate 10 shown in FIG. 2 except that the second protective film 502 having the second adhesive layer 402 as the outermost layer at the first principal face 201 side of the transparent substrate 20 and the first protective film 501 as the outermost layer at the second principal face 202 side of the transparent substrate 20 are further included. As described above, the liquid repellent laminate 10 shown in FIG. 2 generally exists in the form of the liquid repellent laminate 100 illustrated in FIG. 3 in a distribution process before being stuck to a display or the like. As described below, the first protective film 501 is laminated releasably from the first adhesive layer 401, and the second protective film 502 is laminated releasably from the liquid repellent membrane 30 together with the second adhesive layer 402.

A step when the liquid repellent laminate 100 shown in FIG. 3 is stuck to a display will be described. First, the first protective film 501 is released from the liquid repellent laminate 100, thereby exposing the first adhesive layer 401. Subsequently, the first adhesive layer 401 is adhered to a display area of a display. Subsequently, from the laminate adhered to the display, the second protective film 502 is released. Here, the adhesive strength of the second adhesive layer 402 to the second protective film 502 is higher than the adhesive strength of the second adhesive layer 402 to the liquid repellent membrane 30. Further, the adhesive strength of the second adhesive layer 402 to the liquid repellent membrane 30 is lower than the adhesive strength of the first adhesive layer 401 to each of the display and the transparent substrate 20. Therefore, when the second protective film 502 is released from the liquid repellent laminate 100, the second adhesive layer 402 is also released together with the second protective film 502. As a result, the display area of the display is in a state of being protected by the liquid repellent laminate 10 shown in FIG. 2 adhered through the first adhesive layer 401.

(First and Second Adhesive Layers)

An adhesive to be used for forming the first adhesive layer 401 and the second adhesive layer 402 need only be an adhesive that satisfies the above-mentioned relationship of the adhesive strength. A material of the adhesive is not particularly limited, and for example, may be a thermoplastic resin or a thermosetting resin, and may be appropriately selected according to the type of a molded body or the like.

The thickness of the first adhesive layer 401 may be, for example, between 100 nm and 10 μm.

The thickness of the second adhesive layer 402 may be, for example, between 100 nm and 10 μm.

(First and Second Protective Films)

As a material of the first protective film 501 and the second protective film 502, for example, a polyethylene-based resin, a polypropylene-based resin, a polystyrene-based resin, a polyethylene terephthalate-based resin, or the like can be preferably used, and a film obtained by molding one type or two or more types thereof into a monolayer or a multilayer can be used as the protective film.

The thickness of the first protective film 501 and the second protective film 502 may be, for example, between 20 μm and 100 μm.

As a method for obtaining from the liquid repellent laminate 1 shown in FIG. 1 the liquid repellent laminate 100 shown in FIG. 3, the following method can be exemplified.

1) An adhesive to be used for forming the first adhesive layer 401 or the second adhesive layer 402 is dissolved in an appropriate solvent. The obtained solution is applied onto the releasable first protective film 501 or the releasable second protective film 502, followed by drying, thereby forming the first adhesive layer 401 or the second adhesive layer 402. Subsequently, the liquid repellent laminate 1 is press-bonded. During the press-bonding, heating may be performed as needed.

2) When the material of the adhesive for forming the first adhesive layer 401 or the second adhesive layer 402 is a thermoplastic resin, the adhesive is laminated on the releasable first protective film 501 or the releasable second protective film 502 by melt extrusion. Subsequently, the liquid repellent laminate 1 is press-bonded. During the press-bonding, heating may be performed as needed.

3) When the material of the adhesive for forming the first adhesive layer 401 or the second adhesive layer 402 is a thermoplastic resin, the adhesive is laminated on the transparent substrate 20 or the liquid repellent membrane 30 of the liquid repellent laminate 1 by melt extrusion. Subsequently, the releasable first protective film 501 or the releasable second protective film 502 is press-bonded. During the press-bonding, heating may be performed as needed.

<Effects>

The above-mentioned liquid repellent laminates have excellent liquid repellency and abrasion resistance, and therefore are useful not only as a film to be stuck to a display area of a display or the like, but also as a film for protecting various types of members. Further, according to the above-mentioned liquid repellent laminates, problems of environmental load and working environment can be significantly improved.

### EXAMPLES

The performance of the liquid repellent membrane described above was confirmed as follows.

### Example

First, as the transparent substrate, a PET film was prepared. Subsequently, the film was subjected to a plasma treatment in a reduced pressure atmosphere containing an argon-oxygen mixed gas.

Subsequently, a fluorine compound was supplied to this film by a vacuum deposition method. Then, hydrolysis and dehydration condensation were caused, thereby binding the fluorine compound to the surface of the film and also allowing intermolecular bonding of the fluorine compound to occur. The fluorine compound used here is represented by the above general formula (1), and is a compound in which p and n are 1 and 10, respectively. In this manner, a composite film having a liquid repellent membrane on the film was formed.

### Comparative Example

First, the same film as used in Example was prepared. Subsequently, the film was subjected to the same plasma treatment as performed in Example. Subsequently, on the film, a fluorine compound-containing membrane was formed by a coating method. The fluorine compound used here is CYTOP (registered trademark: Type A) manufactured by Asahi Glass Co., Ltd. The fluorine compound is a compound having a terminal group containing an alkoxysilane group at both terminals of a polymer main chain represented by the following chemical formula (4). Then, hydrolysis and dehydration condensation were caused, thereby binding the fluorine compound to the surface of the film. In this manner, a composite film having a liquid repellent membrane on the transparent film was formed.

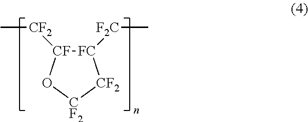

### Test Example 1

The films of Example and Comparative Example were cut to a width of 15 mm. Each of these samples was dipped in an inkjet ink for several seconds in such a manner that the principal face thereof was parallel to the gravity direction. Then, only a portion with a length of 45 mm of each sample was pulled up from the ink, and a time required for the ink to disappear from the pulled up portion was measured. As a result, the ink disappeared from the pulled up portion immediately after the portion was pulled up from the ink in both samples.

### Test Example 2

The same samples as described above were prepared, and the surfaces of these samples were rubbed back and forth 10000 times with a rubber plate. Each sample after being rubbed was dipped in an inkjet ink for several seconds in such a manner that the principal face thereof was parallel to the gravity direction. Then, only a portion with a length of 45 mm of each sample was pulled up from the ink, and a time required for the ink to disappear from the pulled up portion was measured.

As a result, in the sample of Example, the ink disappeared from the pulled up portion immediately after the portion was pulled up from the ink. On the other hand, in the sample of Comparative Example, the ink did not disappear from the portion pulled up from the ink. The reason why the decrease in liquid repellency occurred in the composite film of Comparative Example in this manner is considered that the conformation of the fluorine compound was changed by rubbing, and a group that largely contributes to the liquid repellency was reduced on the surface of the liquid repellent membrane.

From the results of the above Test Examples 1 and 2, it is found that the liquid repellent laminate according to this embodiment has excellent liquid repellency and abrasion resistance.

The invention is not limited to the embodiments described above and can be modified variously without departing from the gist of the invention at an implementation stage. Also, the respective embodiments may be appropriately combined and carried out, and combined effects can be obtained in that case. Further, the embodiments described above include various inventions, and various inventions can be extracted by combinations selected from a plurality of disclosed constituent elements. For example, even if several constituent elements are deleted from all the constituent elements described in the embodiments, a configuration in which the constituent elements are deleted can be extracted as the invention when the problem can be solved and the effect can be obtained.

What is claimed is:

1. A liquid repellent laminate comprising:
a transparent substrate having a first principal face and a second principal face as a rear face of the first principal face; and
a liquid repellent membrane supported on the first principal face of the transparent substrate, wherein
the liquid repellent membrane is a monomolecular membrane of a fluorine-containing organic compound that binds to a surface of the transparent substrate through a binding moiety represented by —Z—O—* (wherein Z represents an atomic group comprising a Si atom, and * represents a binding site to the surface of the transparent substrate) and includes a perfluoroalkyl group having 4 or less carbon atoms at a terminal, and
the fluorine-containing organic compound undergoes intermolecular bonding between the fluorine-containing organic compounds adjacent to each other by mutual binding of Z in the formula.

2. The laminate according to claim 1, wherein
Z in the formula is an atomic group comprising the Si atom and a C atom that binds to the O atom in the formula, and the intermolecular bond formed by mutual binding of the Z is a —C—Si—C—Si— chain or
Z in the formula is an atomic group comprising an O atom and the Si atom that binds to the O atom in the formula, and the intermolecular bond formed by mutual binding of the Z is a —Si—O—Si—O— chain.

3. The laminate according to claim 1, further comprising an adhesive layer supported on the second principal face of the transparent substrate.

4. The laminate according to claim 1, further comprising a protective film releasably laminated as an outermost layer at each of the first principal face side and the second principal face side of the transparent substrate.

5. The laminate according to claim 1, wherein the transparent substrate comprises polyethylene terephthalate (PET), polybutylene terephthalate, polyethylene naphthalate (PEN), polycarbonate, a methyl polymethacrylate copolymer, triacetyl cellulose, a polyolefin, a polyamide, polyvinyl chloride, an amorphous polyolefin, a cycloolefin polymer, a cycloolefin copolymer, an acrylate resin, or a urethane acrylate resin.

6. The laminate according to claim 1, wherein the transparent substrate further comprises a colorant, an antistatic agent, a UV absorber, an antioxidant, a lubricant, a catalyst, and/or another resin.

7. The laminate according to claim 1, wherein the transparent substrate has a thickness of from 50 μm to 100 μm.

8. The laminate according to claim 1, wherein the liquid repellent membrane has a thickness of from 10 nm to 100 nm.

9. The laminate according to claim 3, wherein the adhesive layer comprises a thermoplastic resin or a thermosetting resin.

10. The laminate according to claim 4, wherein the protective film comprises a polyethylene-based resin, a polypropylene-based resin, a polystyrene-based resin, or a polyethylene terephthalate-based resin.

11. The laminate according to claim 1, wherein the transparent substrate has the first principal face is modified to comprise hydroxy groups by ion plasma treatment.

12. A protective sheet for a display, comprising the liquid repellent laminate according to claim 1.
